(19) United States
(12) Patent Application Publication
(10) Pub. No.: US 2014/0241162 A1
(43) Pub. Date: Aug. 28, 2014

(54) Method of Enhancing Processing Capabilities in a Communications Network

(71) Applicants: Veli Pekka Juhani Anttalainen, Helsenki (FI); Tuomo Petteri Flystrom, Espoo (FI); Maunu Elias Holma, Helsinki (FI); Shivakumar Pk, Bangalore (IN); Juha Pekka Sipila, Klaukkala (FI)

(72) Inventors: Veli Pekka Juhani Anttalainen, Helsenki (FI); Tuomo Petteri Flystrom, Espoo (FI); Maunu Elias Holma, Helsinki (FI); Shivakumar Pk, Bangalore (IN); Juha Pekka Sipila, Klaukkala (FI)

(73) Assignee: Nokia Solutions and Networkds Oy, Espoo (FI)

(21) Appl. No.: 14/348,179

(22) PCT Filed: Sep. 28, 2011
(86) PCT No.: PCT/EP2011/066845

§ 371 Date: Apr. 17, 2014

(51) Int. Cl. H04W 28/08

(52) U.S. Cl. CPC H04W 28/08
USPC 370/235

(57) ABSTRACT

A method of enhancing processing capabilities in a communications network is provided. The method includes receiving a request to process a mobile station at a first control node of the network, detecting that the mobile station requires processing support, and assigning at least a part of processing of the mobile station to a second control node capable of handling the processing. The first control node configures the second control node over an interface between the control nodes, and the assigning includes routing data traffic from the mobile station through the second control node after the first control node has configured the second control node over an interface between the control nodes.

### FIELD OF THE INVENTION

The invention generally relates to a method of enhancing processing capabilities in a communications network. More particularly, the invention relates to enhancing the processing capabilities of one or more control nodes (for example radio network controllers (RNCs) or base station controllers (BSCs)) in a communications network (e.g., a 3GPP WCDMA RAN network, an LTE RAN network, a core network, etc.) for processing data traffic from to and from mobile station(s) or user equipment accessing the network.

### BACKGROUND OF THE INVENTION

In a 3G WCDMA Radio Access Network (RAN), a radio network subsystem (RNS) includes a radio network controller (RNC), which controls several Node Bs. The RNC also controls the cells in which the Node Bs are located and performs mobile station (UE) specific processing (for example macro-diversity processing) for all UEs under those cells. Each RNS has a dedicated RNC network element (NE) that does all the processing for its own RNS. This processing includes Node B processing, cell processing and UE-specific processing.

Network operators want to support coverage for new features in each 3GPP release, for example full coverage for the highest peak rates of packet data. Each time there is an increase in the peak rate supported for a UE, this cannot be satisfied only with SW upgrades in the RNC and NodeBs. Enhancing the processing ability is mandatory. Therefore, the operators may need to replace the network hardware of all RNCs frequently in order to process increasing amounts of data traffic from UEs accessing the network, even though only a few UEs may be able to actually use the newest features (e.g. the highest peak rates). Furthermore, in some cases an operator cannot enable the RNC to process higher data rates just by replacing some parts of the RNC hardware step by step. All RNC hardware must be replaced by the operator in order to support new hardware-dependent functionality. This is very costly and time consuming, especially if only a few UEs accessing the network are capable of using the new functionality.

Furthermore, traffic in certain radio network subsystems may fluctuate from time to time, depending on the time of day, the day of the week, or even the season. Therefore the RNC network element (NE) capacity may be only partially used at certain times.

One way to solve this problem is to increase the RNC NE capacity to smooth down the traffic fluctuations. However, this could adversely affect the network availability if the RNC NE were to fail, since the failure of a single RNC NE affects a larger part of the network than just the RNC NE itself.

Therefore, a method is required that allows the RNCs in a network to process data traffic from UEs accessing the network more efficiently and also load balance between the RNCs to combat traffic fluctuations.

### SUMMARY OF THE INVENTION

Accordingly, the invention provides a method of enhancing processing capabilities in a communications network. The method includes receiving a request to process a mobile station at a first control node of the network, detecting that the mobile station requires processing support, and assigning at least a part of processing of the mobile station to a second control node capable of handling the processing. The first control node configures the second control node over an interface between the control nodes. Assigning part or all of the processing of the mobile station to a second control node means that data traffic is routed (either directly or indirectly, and either partially or completely) through the second control node after the first control node has configured the second control node over an interface between the control nodes. Data traffic from the mobile station may be routed from the mobile station or from the core network completely through the second control node after the first control node has configured the second control node over the interface. In this context, data traffic may or may not include radio resource control messages and other control messages between RNC and the UE.

In this way, the first and second control nodes can share the processing load, and control nodes (RNCs) that are not capable of providing certain services, for example a “high peak data rate” service, which the mobile station is capable of but the control node is not, can simply transfer processing from the mobile station to another control node. Therefore, the network will still be capable of delivering high peak data rate services, for example, without the expense and time required for installing a completely new hardware to the control node.

Routing data traffic from the mobile station through the second control node preferably takes place by passing an IP address of an interface of the second control node to the core network as well as a network node providing the mobile station with access to the network. This IP address can be passed specifically for each mobile station, so that traffic from the core network can be routed directly to the second control node and traffic from network node providing the mobile station with access to network can be routed directly to the second control node.

In one embodiment, a network node (mobile station access node; i.e., a base station or Node-B) knows one IP address per first control node and one IP address per second control node. Assignment of those two IP addresses is specific to the mobile station, so that traffic from each mobile station can be forwarded to either IP address, independently of the other mobile stations. In this way, the network node (base station or Node B) does not know that it is communicating with the second control node instead of the first control node.

In another embodiment of the invention, only a part of the traffic from the mobile station is routed to the second control node if it is detected that the mobile station requires processing support from the second control node. In this case, the rest of the traffic is processed by the first control node. An additional processing requirement may arise due to the mobile station having an increased peak data rate capability, or due to additional data traffic from another mobile station accessing the network, for example.

Traffic to the second control node (the “processing” control node) can be routed through the first control node (the “owning” control node), or the network node is able to route the traffic to two different control nodes (e.g. the first and second control nodes).

The invention also provides a communications network. The network includes a network node for allowing a mobile station to access the network. A first control node is associated with the network node. The first control node includes a receiver for receiving data traffic from a mobile station, a processor for processing the data traffic, and a detector for detecting an additional processing requirement of the data traffic from the mobile station. A second control node is also provided, which has a higher processing capability for the data traffic from the mobile station. Furthermore, the network includes a router. The first control node is adapted to assign processing of the data traffic to the second control node if the detector detects the additional processing requirement.

In a preferred embodiment, the router is statically configured so that data traffic is routed from a core network and from the network node to the second control node when the first control node assigns complete processing of the data traffic to the second control node and informs the core network and network node of the appropriate IP address of the second control node.

The router can be configured statically so that each control node has its own IP address(es) distinct from the other control node. At establishment of mobile station-specific or call-specific connections, the network node and core network get an appropriate IP address from the first control node, depending on whether the first control node or the second control node is going to process that mobile station or call.

An interface is provided between the first and second control nodes, which can be utilized by the first control node to reserve additional processing resources in the second control node for the mobile station needing additional processing resources. The router may be provided either within the interface or outside and additionally to it.

Either a site router on Iub side can be used, or the network node can route traffic to multiple control node destinations (e.g. the first and second control nodes), based on a call-specific IP address (i.e. perform a next-hop decision differently for different IP addresses). In other words, if there is a site router on the Iub interface side then the network node need not support routing to multiple control nodes. If there is no site router on Iub side then the Node-B SW should support routing to multiple control nodes.

The second control node can be functionally similar to the first control node but it has a higher processing capability (for example, it can process higher peak data rate traffic from the mobile station). The interface is a “co-use” interface between the two control nodes and can be used instead of or in addition to an existing interface between the two control nodes, e.g., the Iur interface or other interfaces.

The second control node may also have functionalities that are different from first control node, as long as it can provide the necessary processing services to first control node.

The invention will now be described, by way of example only, with reference to specific embodiments, and to the accompanying drawings, in which:

### BRIEF DESCRIPTION OF THE DRAWINGS

FIG. 1 is a simplified schematic block diagram of a communications network according to the invention.

### DETAILED DESCRIPTION OF EXEMPLARY EMBODIMENTS

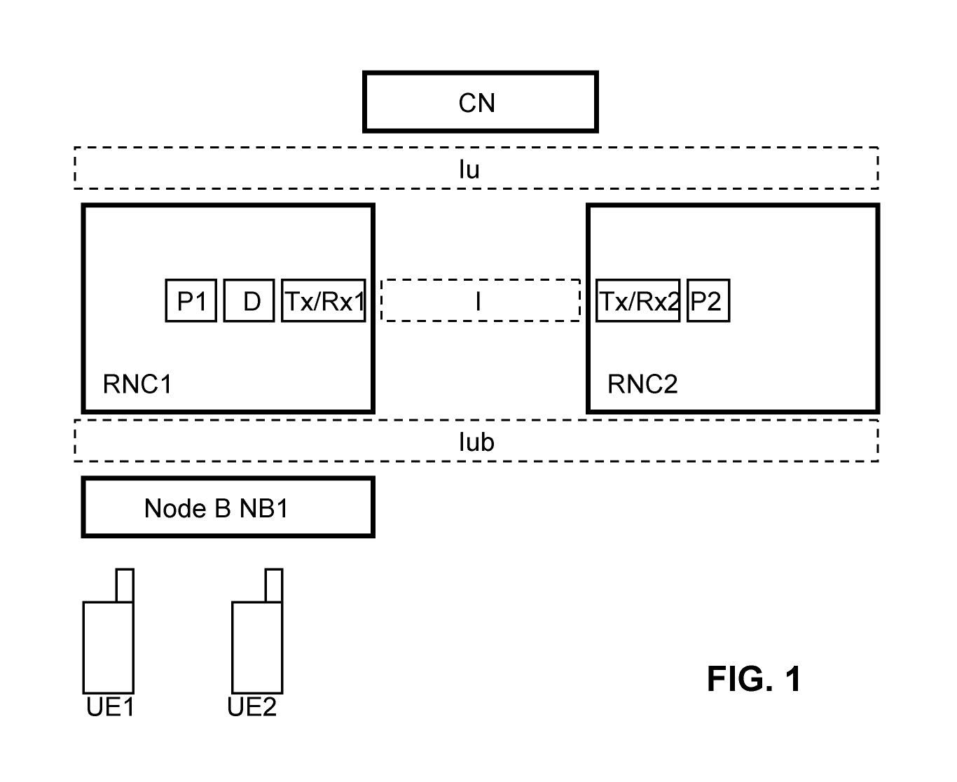

FIG. 1 shows a wireless communications network, which is illustrated in this example as a 3GPP Radio Access Network (RAN) but could also be any other wireless communications network. The network in FIG. 1 has a base station or Node B NB1 as a network node controlled by an owning radio network controller RNC1 over an interface Iub and a processing radio network controller RNC2. Mobile stations UE1 and UE2 can access the network via the Node B NB1. The radio network controller RNC1 has a transceiver Tx/Rx1 via which it can exchange data traffic with a transceiver Tx/Rx2 in the other radio network controller RNC2 over an interface I. The interface I is a co-use interface between the two radio network controllers or control nodes RNC1 and RNC2. Both network controllers RNC1 and RNC2 are interfaced with the core network CN over independent Iu interfaces.

As well as a transceiver Tx/Rx1, Tx/Rx2, each radio network controller RNC1, RNC2 has a respective processor P1, P2. The processor P2 in the radio network controller RNC2 has a higher processing capability than the processor P1 in the radio network controller RNC1. However, both RNCs RNC1 and RNC2 are functionally similar to each other. In addition, the network controller RNC1 includes a detector D for detecting that data traffic from the mobile station UE1, UE2 accessing the network has a higher processing requirement than the network controller RNC1 is able to support.

In the following example, the mobile station UE1 has a peak data rate of 80 Mbps, whereas the mobile station UE2 has a peak data rate of 160 Mbps. The processor P1 in the radio network controller RNC1 can only support a maximum data rate of 80 Mbps, whereas the processor P2 in RNC2 is able to support higher data rates. Therefore, the radio network controller RNC1 can process data traffic from the mobile station UE1 but requires either partial or complete support to process data traffic from UE2.

When the mobile station UE2 wishes to access the network it sends a connection request message to the Node B NB1 to connect with the network. A connection is then set up between the mobile station UE2 and the Node B NB1 and exchange of data traffic between the mobile station UE2 and the network begins.

Since the radio network controller RNC1 controls the Node B NB1, data traffic from the mobile station UE2 is processed by the processor P1 in the radio network controller RNC1. If the peak data rate of traffic from the UE2 being processed by the processor P1 exceeds 80 Mbps, the maximum it can deal with, the detector D detects that the mobile station UE2 requires processing support.

The radio network controller RNC1 configures the other radio network controller RNC2 over the interface I to receive data traffic from the mobile station UE2. It then configures the core network and network node for UE2 in such a way that, utilizing the statically configured routing in the network, all of the traffic from the mobile station UE2 to the other radio network controller RNC2 (specifically the processor P2) is routed through the other radio network controller RNC2 directly through the interface Iub of the second radio network controller RNC2.

The radio network controller RNC1 routes data traffic from the mobile station UE2 through the other radio network controller RNC2 by passing an IP address of the appropriate core network CN port of the network controller RNC2 to the core network CN as well as the IP address of an appropriate Iub port of the network controller RNC2 to the Node B NB1 providing the mobile station UE2 with access to the network. Since the IP address is applied specifically for each mobile station (rather than applying the same IP address for all mobile stations), the Node B NB1 does not know that it is communicating with another radio network controller RNC2 instead of RNC1, by which it is being controlled. The same is true for the core network CN.

In an alternative embodiment, data traffic is routed through the network controller RNC1 to the other network controller RNC2. In this case, the first network controller RNC1 gives one of its own core network port IP addresses to the core network CN and one of its own Iub port IP addresses to the Node-B NB1. Then the first radio network controller RNC1 routes the traffic further to the second radio network controller RNC2 through the interface I. The processor P2 in the radio network controller RNC2 then processes traffic from the mobile station UE2 caused by the increased peak data rates of the mobile station UE2.

For routing data traffic, either a site router on the Iub interface side is required, or the Node B NB1 has to route UL traffic to multiple RNC destinations (e.g. the network controllers RNC1 and RNC2), based on a call-specifically applied IP address (i.e. perform next-hop decisions differently for different IP addresses). In other words, if there is a site router on the Iub interface side then the Node B NB1 need not be enhanced to support multiple RNC destinations. If there is no site router on Iub side then Node B NB1 has to be enhanced.

In another embodiment of the invention, the mobile stations UE1 and UE2 both have peak data rates of 80 Mbps but the radio network controller RNC1 has already reached its processing capacity when the mobile station UE2 requests to connect to the network. In this case, the detector D detects that the mobile station UE2 requires an additional processing capability and the radio network controller RNC1 routes all traffic from the mobile station UE2 to the other radio network controller RNC2 in the manner described above.

Although the invention has been described hereinabove with reference to specific embodiments, it is not limited to these embodiments, and no doubt further alternatives will occur to the skilled person that lie within the scope of the invention as claimed.

1. A method of enhancing processing capabilities in a communications network, the method comprising receiving a request to process a mobile station at a first control node of the network, detecting that the mobile station requires processing support, and assigning at least a part of processing of the mobile station to a second control node capable of handling said processing, characterized in that the first control node configures the second control node over an interface between the control nodes, and the assigning comprises routing data traffic from the mobile station through the second control node after the first control node has configured the second control node over the interface between the control nodes.

2. The method according to claim 1, wherein the step of routing takes place by passing an IP address of an interface of the second control node to a core network as well as a network node providing the mobile station with access to the network.

3. The method according to claim 2, wherein an IP address of the second control node is applied for mobile stations whose traffic needs to be routed through the second control node, and an IP address of the first control node is applied for mobile stations whose traffic needs to be routed through first control node.

4. The method according to claim 1, wherein only a part of the traffic from the mobile station is routed to the second control node if it is detected that the mobile station requires processing support from the second control node.

5. The method according to claim 1, wherein the additional processing support arises from an additional processing requirement due to a mobile station-specific service.

6. The method according to claim 1, wherein the additional processing requirement is an increased mobile station peak rate capability.

7. The method according to claim 1, wherein the additional processing requirement is additional data traffic from a further mobile station.

8. A communications network, comprising:
a network node for allowing a mobile station to access the network;
a first control node associated with the network node, the first control node including a receiver for receiving data traffic from the mobile station, a processor for processing the data traffic, and a detector for detecting an additional processing requirement of the data traffic from the mobile station; and
a second control node having a higher processing capability than the first control node for the data traffic from the mobile station,
characterized in that the network further comprises a router, wherein the first control node is adapted to assign processing of the data traffic to the second control node if the detector detects said additional processing requirement and the router is configured such that traffic is routed from a core network and from the network node to the second control node when the first control node assigns complete processing of the data traffic to the second control node; and
an interface between the first and second control nodes which can be utilized by the first control node to reserve additional processing resources in the second control node for the mobile station needing the said additional resources.
